(19) United States
(12) Patent Application Publication
(10) Pub. No.: US 2024/0202414 A1
(43) Pub. Date: Jun. 20, 2024

(54) EQUIVALENT CIRCUIT MODEL CREATION METHOD FOR MULTI-TERMINAL CAPACITORS, NON-TRANSITORY COMPUTER-READABLE MEDIUM INCLUDING EQUIVALENT CIRCUIT MODEL CREATION PROGRAM, SIMULATION METHOD, AND SIMULATION DEVICE

(71) Applicant: Murata Manufacturing Co., Ltd., Nagaokakyo-shi (JP)

(72) Inventors: Seiji HIDAKA, Nagaokakyo-shi (JP); Atsutaka MORI, Nagaokakyo-shi (JP); Yukihiro FUJITA, Nagaokakyo-shi (JP)

(21) Appl. No.: 18/586,780

(22) Filed: Feb. 26, 2024

Related U.S. Application Data
(63) Continuation of application No. PCT/JP2022/031871, filed on Aug. 24, 2022.

(30) Foreign Application Priority Data
Sep. 6, 2021 (JP) 2021-145012

(51) Int. Cl. G06F 30/367; G06F 119/06

(52) U.S. Cl. CPC G06F 30/367; G06F 2119/06

(57) ABSTRACT

A method for creating an equivalent circuit model of a multi-terminal capacitor including staggered positive and negative outer electrode terminals includes measuring S parameters of the multi-terminal capacitor, deriving a total impedance of the multi-terminal capacitor based on S-parameter measurement values, creating a two-terminal equivalent circuit model from the derived total impedance of the multi-terminal capacitor, deriving a unit-cell equivalent circuit model from the created two-terminal equivalent circuit model, creating a two-dimensional grid topology by combining the derived unit-cell equivalent circuit model and a parasitic-component equivalent circuit model, and setting terminals of the multi-terminal capacitor at nodes in the created two-dimensional grid topology.

### CROSS REFERENCE TO RELATED APPLICATIONS

This application claims the benefit of priority to Japanese Patent Application No. 2021-145012, filed on Sep. 6, 2021, and is a Continuation application of PCT Application No. PCT/JP2022/031871, filed on Aug. 24, 2022. The entire contents of each application are hereby incorporated herein by reference.

### BACKGROUND OF THE INVENTION

### 1. Field of the Invention

The present disclosure relates to equivalent circuit model creation methods for multi-terminal capacitors, non-transitory computer-readable media including equivalent circuit model creation programs, a simulation method, and a simulation device.

### 2. Description of the Related Art

A method for deriving equivalent circuit models of capacitors is disclosed in Japanese Unexamined Patent Application Publication No. 2002-259482. The method disclosed in Japanese Unexamined Patent Application Publication No. 2002-259482 targets two-terminal capacitors. More specifically, the method disclosed in Japanese Unexamined Patent Application Publication No. 2002-259482 has been developed for the purpose of deriving equivalent circuit models of two-terminal capacitors.

The method disclosed in Japanese Unexamined Patent Application Publication No. 2002-259482 is unable to derive equivalent circuit models for capacitors with more than two terminals, that is, three or more terminals.

### SUMMARY OF THE INVENTION

Example embodiments of the present invention provide equivalent circuit model creation methods, non-transitory computer-readable media including equivalent circuit model creation programs, simulation methods, and simulation devices that each enable derivation of equivalent circuit models for multi-terminal capacitors with three or more terminals.

According to an example embodiment of the present invention, an equivalent circuit model creation method for creating an equivalent circuit model of a multi-terminal capacitor including positive and negative outer electrode terminal linear arrays are alternately arranged in parallel or substantially in parallel. The equivalent circuit model creation method includes measuring S parameters of the multi-terminal capacitor, deriving a total impedance of the multi-terminal capacitor based on S-parameter measurement values measured in the measuring the S parameters, creating a two-terminal equivalent circuit model from the total impedance of the multi-terminal capacitor derived in the deriving the total impedance, deriving a unit-cell equivalent circuit model from the two-terminal equivalent circuit model created in the creating the two-terminal equivalent circuit model, creating a two-dimensional grid topology by combining the unit-cell equivalent circuit model derived in the deriving the unit-cell equivalent circuit model and a parasitic-component equivalent circuit model, and setting terminals of the multi-terminal capacitor at nodes in the two-dimensional grid topology created in the creating the two-dimensional grid topology.

According to an example embodiment of the present invention, a non-transitory computer-readable medium including an equivalent circuit model creation program is provided for creating an equivalent circuit model of a multi-terminal capacitor including positive and negative outer electrode terminal linear arrays are alternately arranged in parallel or substantially in parallel. The equivalent circuit model creation program causes a computer to execute a process including measuring S parameters of the multi-terminal capacitor, deriving a total impedance of the multi-terminal capacitor based on S-parameter measurement values measured in the measuring the S parameters, creating a two-terminal equivalent circuit model from the total impedance of the multi-terminal capacitor derived in the deriving the total impedance, deriving a unit-cell equivalent circuit model from the two-terminal equivalent circuit model created in the creating the two-terminal equivalent circuit model, creating a two-dimensional grid topology by combining the unit-cell equivalent circuit model derived in the deriving the unit-cell equivalent circuit model and a parasitic-component equivalent circuit model, and setting terminals of the multi-terminal capacitor at nodes in the two-dimensional grid topology created in the creating the two-dimensional grid topology.

According to an example embodiment of the present invention, a simulation method is provided for calculating characteristics of a multi-terminal capacitor or characteristics of a circuit including the multi-terminal capacitor by using an equivalent circuit model of the multi-terminal capacitor created through an equivalent circuit model creation method according to an example embodiment of the present invention.

According to an example embodiment of the present invention, a simulation device for calculating characteristics of a multi-terminal capacitor or characteristics of a circuit including the multi-terminal capacitor by using an equivalent circuit model of the multi-terminal capacitor created through an equivalent circuit model creation method according to an example embodiment of the present invention.

According to example embodiments of the present invention, equivalent circuit models of capacitors including three or more terminals can be derived.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a flowchart illustrating an example of an equivalent circuit model creation method for multi-terminal capacitors according to an example embodiment of the present invention.

FIG. 2 is a plan view of an example structure of a multi-terminal capacitor according to an example embodiment of the present invention.

FIG. 3 illustrates a section of a portion in FIG. 2.

FIG. 4 is an enlarged partial sectional view of the multi-terminal capacitor.

FIG. 5 is an enlarged partial sectional view of the multi-terminal capacitor.

FIG. 6 illustrates a jig for measuring S parameters according to an example embodiment of the present invention.

FIG. 7 illustrates a section of a portion in FIG. 6.

FIG. 8 illustrates a section of a portion in FIG. 6.

FIG. 9 illustrates an equivalent circuit of a substrate including the multi-terminal capacitor.

FIG. 10 illustrates a base configuration of an equivalent circuit.

FIG. 11 illustrates an equivalent circuit to fit across lower frequencies.

FIG. 12 illustrates an equivalent circuit to fit across an entire frequency range including lower frequencies.

FIG. 13 is a table tabulating values of the elements included in the circuits illustrated in FIGS. 10 to 12.

FIG. 14 illustrates an example of impedance changes with respect to frequency.

FIG. 15 illustrates an example of equivalent series resistance changes with respect to frequency.

FIG. 16 is a flowchart illustrating an example of a fitting process.

FIG. 17 illustrates an example of measurement values and simulation values of impedance and equivalent series resistance.

FIG. 18 illustrates an example of measurement values and simulation values of impedance and equivalent series resistance.

FIG. 19 illustrates an example of measurement values and simulation values of impedance and equivalent series resistance.

FIG. 20 illustrates an example unit cell.

FIG. 21 illustrates an image of total impedance.

FIG. 22 illustrates an example array of unit cells that corresponds to the total impedance.

FIG. 23 illustrates unit-cell impedances positioned between the nodes of a two-dimensional grid.

FIG. 24 illustrates an example equivalent circuit model of a multi-terminal capacitor.

FIG. 25 is a table illustrating an example of symbols representing equivalent circuit models of multi-terminal capacitors.

FIG. 26 illustrates a multi-terminal capacitor with a terminal arrangement in three rows and three columns.

FIG. 27 illustrates a multi-terminal capacitor illustrated using the symbols presented in FIG. 25.

FIG. 28 illustrates a multi-terminal capacitor with a terminal arrangement in three rows and five columns.

FIG. 29 illustrates an equivalent circuit of a substrate having a multi-terminal capacitor.

FIG. 30 illustrates a simulation result regarding S parameters.

FIG. 31 illustrates an example of simulation in the time domain.

FIG. 32 illustrates the change in current from a current supply in FIG. 31.

FIG. 33 illustrates examples of the change in load voltage.

FIG. 34 illustrates an example configuration of a simulation device of an example embodiment of the present invention.

### DETAILED DESCRIPTION OF THE EXAMPLE EMBODIMENTS

Hereinafter, example embodiments of the present invention will be described in detail with reference to the drawings. In the following descriptions of the example embodiments, configuration elements identical or equivalent to those in other example embodiments are assigned the same reference numerals, and descriptions of these configuration elements will be simplified or omitted. The present invention is not limited by the example embodiments. The constituent elements in the example embodiments include elements that are easily replaceable by those skilled in the art or that are substantially identical. The configuration elements described below can be combined in any appropriate manner. Further, each configuration element can be removed, replaced, or changed without departing from the spirit of the invention.

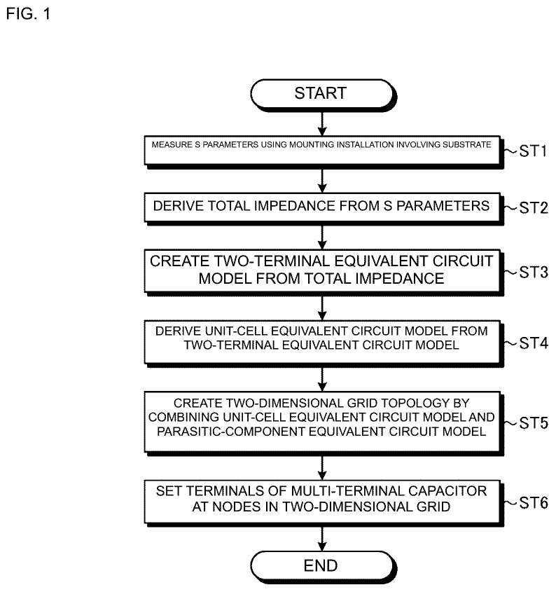

FIG. 1 is a flowchart illustrating an example of an equivalent circuit model creation method for multi-terminal capacitors according to an example embodiment of the present invention. As illustrated in FIG. 1, firstly, a multi-terminal capacitor includes a substrate, and scattering parameters (S parameters) of the multi-terminal capacitor are measured (step ST1). For example, a jig that includes a substrate incorporating the capacitor can be prepared and used to measure S parameters.

Next, the total impedance of the multi-terminal capacitor is calculated based on the S parameters measured in step ST1 (step ST2). Subsequently, a two-terminal equivalent circuit model is created from the total impedance calculated in step ST2 (step ST3). At this time, the two-terminal equivalent circuit model is created through a fitting process. The fitting process will be described later.

A unit-cell equivalent circuit model is derived from the two-terminal equivalent circuit model created in step ST3 (step ST4). At this time, the unit-cell equivalent circuit model is derived from the two-terminal equivalent circuit model to form a specific periodic structure.

Next, a two-dimensional grid topology is created by combining the unit-cell equivalent circuit model derived in step ST4 and a parasitic-component equivalent model circuit (step ST5). Subsequently, the terminals of the multi-terminal capacitor are set at the nodes in the two-dimensional grid created in step ST5 (step ST6).

### Exemplary Structure of Multi-Terminal Capacitor

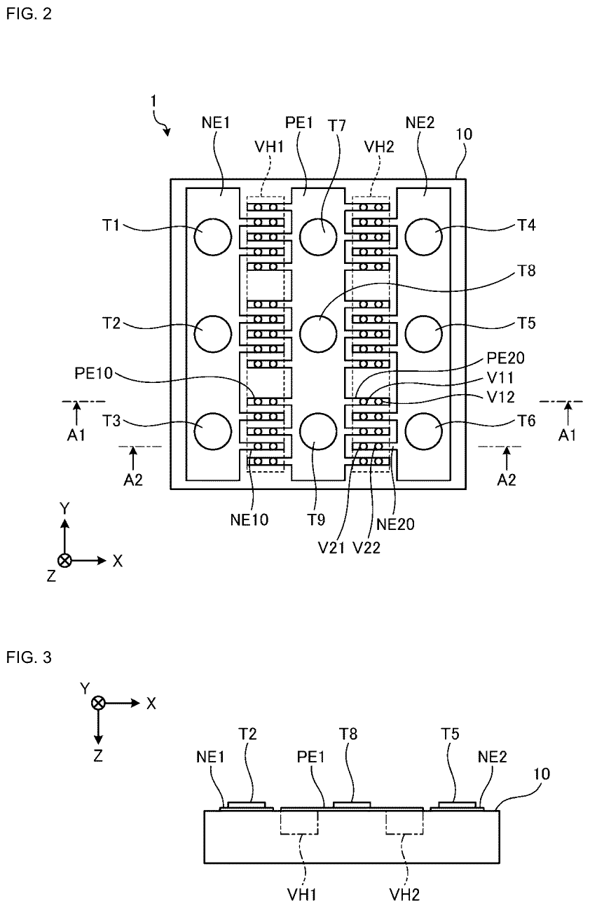

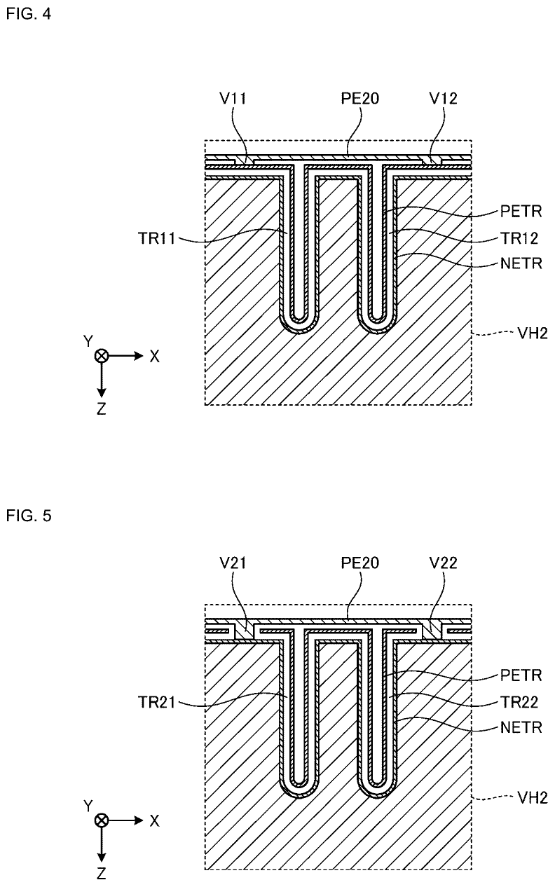

FIGS. 2 to 5 illustrate an example structure of a multi-terminal capacitor. FIG. 2 is a plan view of the example structure of a multi-terminal capacitor. FIG. 3 illustrates a section taken along line A1-A1 in FIG. 2. FIGS. 4 and 5 provide enlarged partial sectional views of the multi-terminal capacitor.

As illustrated in FIG. 2, a multi-terminal capacitor 1 of this example includes the substrate 10. Negative electrodes NE1 and NE2 and a positive electrode PE1 are provided on the substrate 10.

Here, for ease of description, the X-axis direction, the Y-axis direction, and the Z-axis direction, which are orthogonal or substantially orthogonal to each other, are established. The longitudinal direction in which the positive electrode PE1 and the negative electrodes NE1 and NE2 extend corresponds to the Y-axis direction. Referring to FIG. 2, the negative electrode NE1, the positive electrode PE1, and the negative electrode NE2 are arranged in this order. This arrangement direction corresponds to the X-axis direction. The Z-axis direction is defined as the depth direction of a substrate 10.

As illustrated in FIG. 2, the positive electrode PE1 and the negative electrodes NE1 and NE2 extend in the Y-axis direction, positioned parallel or substantially parallel to each other. As such, the positive electrode PE1 and the negative electrodes NE1 and NE2 are arranged in a striped pattern in plan view. The negative electrode NE1 includes terminals T1, T2, and T3. The negative electrode NE2 includes terminals T4, T5, and T6. The positive electrode PE1 includes terminals T7, T8, and T9.

The positive electrode PE1 includes extensions PE10 and PE20 that extend respectively toward the negative electrodes NE1 and NE2 in the X-axis direction. The negative electrode NE1 includes extensions NE10 that extend in the X-axis direction toward the positive electrode PE1. The negative electrode NE2 includes extensions NE20 that extend in the X-axis direction toward the positive electrode PE1. The extensions PE10 and NE10 are alternately arranged in the Y-axis direction within the region between the positive electrode PE1 and the negative electrode NE1. The extensions PE20 and NE20 are alternately arranged in the Y-axis direction within the region between the positive electrode PE1 and the negative electrode NE2.

A trench formation region VH1 is provided between the positive electrode PE1 and the negative electrode NE1. A trench formation region VH2 is provided between the positive electrode PE1 and the negative electrode NE2. Via-holes extending in the Z-axis direction are provided in the portions in the trench formation regions VH1 and VH2 of the extensions PE10, NE10, PE20, and NE20. For example, via-holes V11 and V12 are provided at the portions in the trench formation region VH2 of the extensions PE20, and via-holes V21 and V22 are provided at the portions in the trench formation region VH2 of the extension NE20.

FIG. 4 is an enlarged sectional view of the trench formation region VH2, as taken along A1-A1 in FIG. 2. Referring to FIG. 4, the via-holes V11 and V12 are coupled to a positive electrode PETR inside the substrate 10. As such, the extension PE20 is electrically coupled to the positive electrode PETR.

FIG. 5 is an enlarged sectional view of the trench formation region VH2, as taken along A2-A2 in FIG. 2. Referring to FIG. 5, the via-holes V21 and V22 are coupled to a negative electrode NETR inside the substrate 10. As such, the extension NE20 is electrically coupled to the negative electrode NETR.

Referring to FIGS. 4 and 5, the positive electrode PETR and the negative electrode NETR include portions extending in the Z-axis direction along trenches TR11, TR12, TR21, and TR22. This structure maximizes the area of the portion in which the positive electrode PETR faces the negative electrode NETR to the greatest extent possible, thereby increasing the capacitance between the positive electrode PETR and the negative electrode NETR to the greatest extent possible. A dielectric is provided between the positive electrode PETR and the negative electrode NETR.

FIGS. 2 to 5 illustrate an example multi-terminal capacitor that is, for example, a silicon capacitor, in which the positive and negative linear arrays are arranged in parallel or substantially in parallel. The multi-terminal capacitor may be, for example, a multilayer ceramic capacitor, provided that the positive and negative linear arrays are arranged in parallel or substantially in parallel.

### Measurement of S Parameters

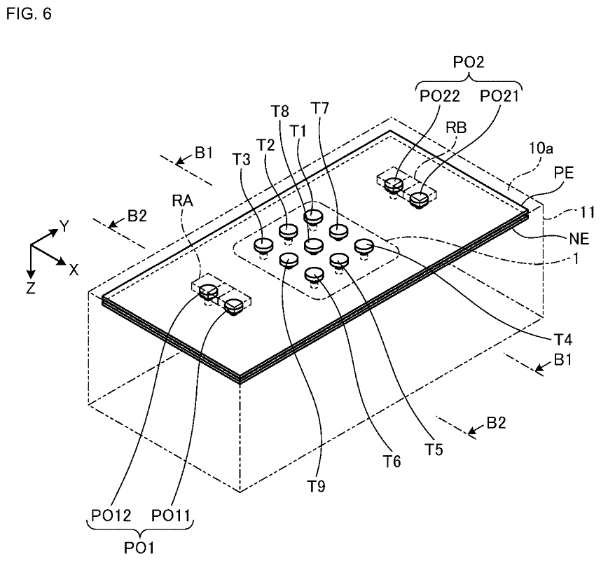

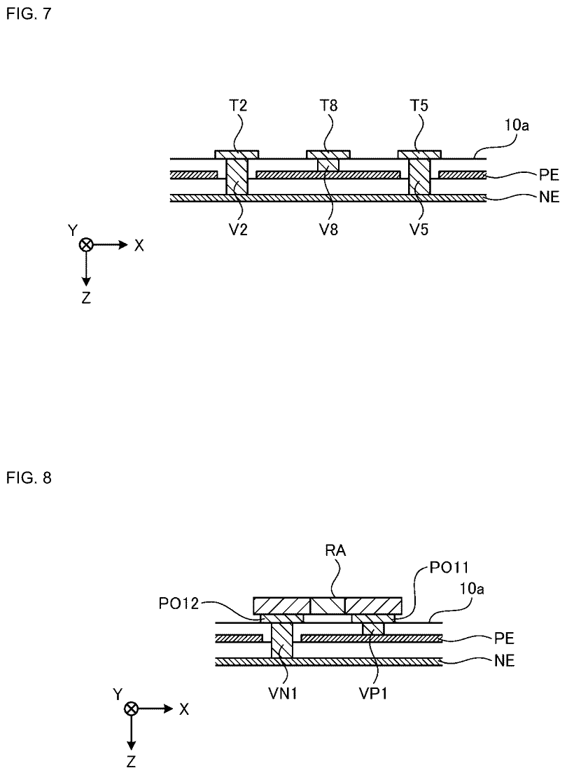

FIG. 6 is provided to describe a method for measuring S parameters of a multi-terminal capacitor. FIG. 6 illustrates a jig for measuring S parameters. FIG. 7 illustrates a section taken along line B1-B1 in FIG. 6. FIG. 8 illustrates a section taken along line B2-B2 in FIG. 6.

In FIG. 6, a jig 11 includes a substrate 10a. The substrate 10a is used to evaluate the multi-terminal capacitor 1. The multi-terminal capacitor 1 is formed with the substrate 10a.

The multi-terminal capacitor 1 includes the nine terminals T1 to T9. The terminals T1 to T3 and T4 to T6 arranged in the Y-axis direction are electrically coupled to a negative electrode inside the substrate 10a. The terminals T7 to T9 arranged in the Y-axis direction are electrically coupled to a positive electrode inside the substrate 10a. For example, as illustrated in FIG. 7, the terminal T2 is electrically coupled to a negative electrode NE inside the substrate 10a by a via-hole V2. The terminal T2 is not coupled to a positive electrode PE inside the substrate 10a. The terminal T5 is electrically coupled to the negative electrode NE inside the substrate 10a by a via-hole V5. The terminal T5 is not coupled to the positive electrode PE inside the substrate 10a. The terminal T8 is electrically coupled to the positive electrode PE inside the substrate 10a by a via-hole V8.

The linear array of the linearly aligned terminals T1 to T3, the linear array of the linearly aligned terminals T4 to T6, and the linear array of the linearly aligned terminals T7 to T9 are parallel to each other. The linear array of the terminals T7 to T9 is positioned between the linear array of the terminals T1 to T3 and the linear array of the terminals T4 to T6. The linear array of the terminals T1 to T3 is positioned on one side of the linear array of the terminals T7 to T9 in the X-axis direction, and the linear array of the terminals T4 to T6 is positioned on the other side. As a result, the multi-terminal capacitor 1 has a configuration in which the linear array of electrodes coupled to the positive pole and the linear array of electrodes coupled to the negative pole are positioned in an alternate manner.

The substrate 10a has ports PO1 and PO2. The port PO1 is provided on one side of the multi-terminal capacitor 1 in the Y-axis direction, and the port PO2 is provided on the other side of the multi-terminal capacitor 1. The port PO1 includes a positive pole PO11 and a negative pole PO12. The port PO2 includes a positive pole PO21 and a negative pole PO22.

To measure S parameters, a resistor RA is electrically coupled between the positive pole PO11 and the negative pole PO12 of the port PO1. Similarly, a resistor RB is electrically coupled between the positive pole PO21 and the negative pole PO22 of the port PO2. The resistors RA and RB are, for example, about 50Ω chip resistors.

As illustrated in FIG. 8, the positive pole PO11 of the port PO1 is electrically coupled to the positive electrode PE inside the substrate 10a by a via-hole VP1. The negative pole PO12 of the port PO1 is electrically coupled to the negative electrode NE inside the substrate 10a by a via-hole VN1. The negative pole PO12 is not coupled to the positive electrode PE inside the substrate 10a. Similarly to the port PO1, the positive pole PO21 of the port PO2 is electrically coupled to the positive electrode PE inside the substrate 10a, and the negative pole PO22 of the port PO2 is electrically coupled to the negative electrode NE inside the substrate 10a.

As illustrated in FIGS. 6 to 8, by using a mounting installation involving a substrate using the jig 11, an equivalent circuit model can be created that reflects the impedance when the positive and negative terminals are in electrical communication. Additionally, by using the mounting installation involving a substrate, the equivalent circuit model can be created while reflecting the characteristics of the parasitic component consisting of joints of the terminals.

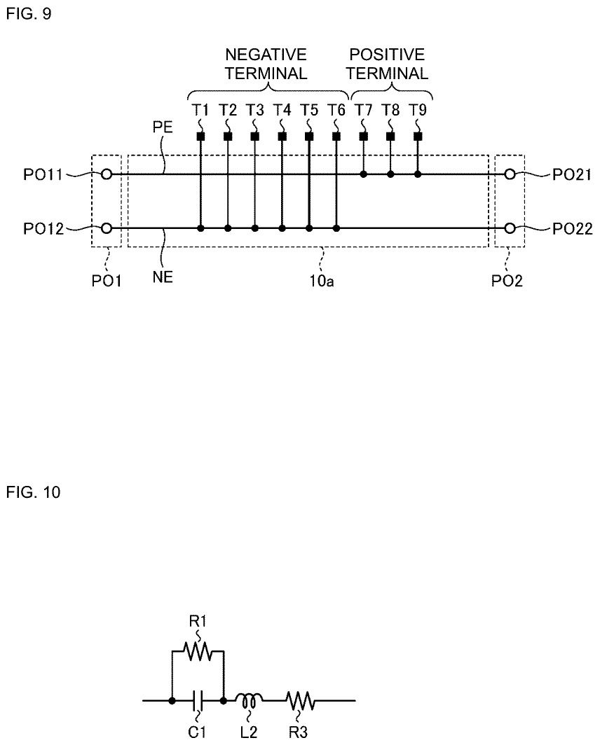

FIG. 9 illustrates an equivalent circuit of the substrate 10a including the multi-terminal capacitor 1. As illustrated in FIG. 9, the positive pole PO11 of the port PO1 is electrically coupled to the positive electrode PE. The positive pole PO21 of the port PO2 is electrically coupled to the positive electrode PE. The negative pole PO12 of the port PO1 is electrically coupled to the negative electrode NE. The negative pole PO22 of the port PO2 is electrically coupled to the negative electrode NE. The terminals T1 to T6 are negative terminals and are electrically coupled to the negative electrode NE. The terminals T7 to T9 are positive terminals and are electrically coupled to the positive electrode PE.

The S parameters of the equivalent circuit illustrated in FIG. 9 are measured using a shunt-through method. At this time, for example, S parameters are measured using a network analyzer. S parameters, also referred to as a scattering matrix or scattering parameters, are parameters that represent the bandpass and reflection power characteristics of a circuit network.

Using the measured S parameters, a total impedance Zₜₒₜₐₗ of the circuit is calculated. The impedance Z is derived according to the following expression (1).

$${Z}_{total} = ( {Z}_{0} / 2 ) \times \{ {S}_{21} / ( 1 - {S}_{21} ) \} \qquad ( 1 )$$

Z₀ represents the characteristic impedance in the above expression (1). S₂₁ represents the power gain when the impedance of a power supply and a load is Z₀.

### Fitting Process

Next, the fitting process will be described. The fitting process is a process for deriving an equivalent circuit that corresponds to the measurement value of the total impedance Zₜₒₜₐₗ of the circuit. The fitting process is the process of matching simulation values to measurement values. Specifically, to match the impedance simulation value obtained from a simulation program with integrated circuit emphasis (SPICE) model to the measurement value, resistive elements, inductive elements, and capacitive elements are combined, so that an equivalent circuit is derived.

FIGS. 10 to 12 illustrate example equivalent circuits for representing the measurement value of the total impedance Zₜₒₜₐₗ of the circuit. FIG. 10 illustrates a base form of the equivalent circuit. The equivalent circuit illustrated in FIG. 10 includes resistive elements R1 and R3, a capacitive element C1, and an inductive element L2. The capacitive element C1, the inductive element L2, and the resistive element R3 are coupled in series. The resistive element R1 is coupled in parallel with the capacitive element C1. The resistive element R1 represents an insulation resistance.

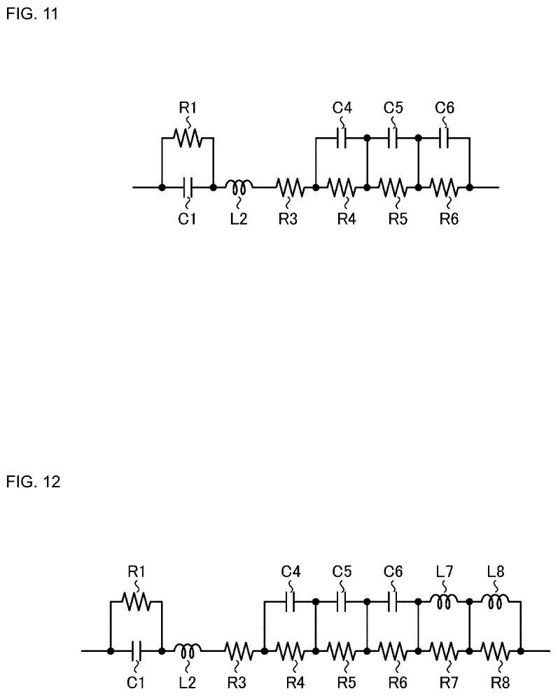

FIG. 11 illustrates an equivalent circuit to fit across lower frequencies. The equivalent circuit illustrated in FIG. 11 includes resistive elements R1 and R3 to R6, capacitive elements C1 and C4 to C6, and an inductive element L2. The capacitive element C1, the inductive element L2, and the resistive elements R3, R4, R5, and R6 are coupled in series. The resistive element R1 is coupled in parallel with the capacitive element C1, the capacitive element C4 with the resistive element R4, the capacitive element C5 with the resistive element R5, and the capacitive element C6 with the resistive element R6. The resistive element R1 represents an insulation resistance.

FIG. 12 illustrates an equivalent circuit to fit across an entire frequency range including lower frequencies. The equivalent circuit illustrated in FIG. 12 includes resistive elements R1 and R3 to R8, capacitive elements C1 and C4 to C6, and inductive elements L2, L7, and L8. The capacitive element C1, the inductive element L2, and the resistive elements R3, R4, R5, R6, R7, and R8 are coupled in series. The resistive element R1 is coupled in parallel with the capacitive element C1, the capacitive element C4 with the resistive element R4, the capacitive element C5 with the resistive element R5, the capacitive element C6 with the resistive element R6, the inductive element L7 with the resistive element R7, and the inductive element L8 with the resistive element R8. The resistive element R1 represents an insulation resistance.

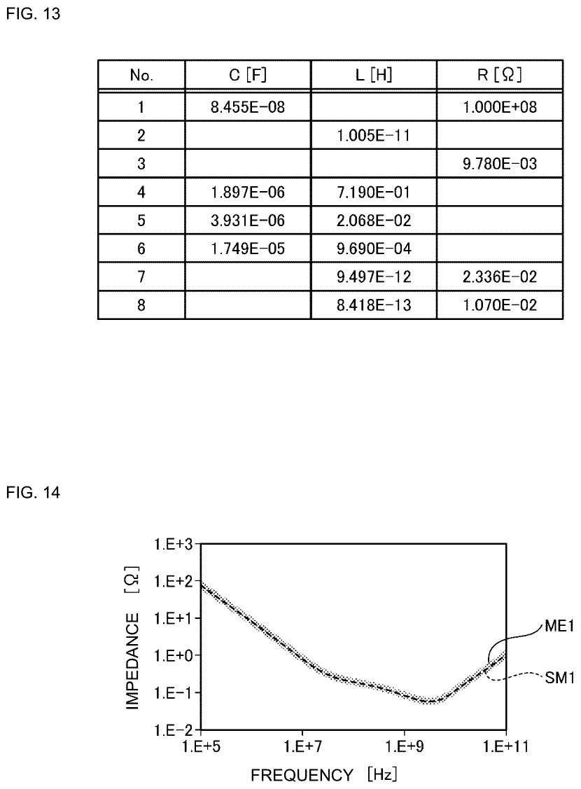

FIG. 13 is a table tabulating values of the elements included in the circuits illustrated in FIGS. 10 to 12. Specifically, the table in FIG. 13 indicates an example of capacitances [F] of the capacitive elements C, inductances [H] of the inductive elements L, and resistances [Ω] of the resistive elements R. The reference numerals for the elements included in the circuits illustrated in FIGS. 10 to 12 are represented by combining numerals 1 to 8 in the “No.” field of the leftmost column of the table with the capacitive element C, the inductive element L, or the resistive element R. For example, the capacitance of the capacitive element C1 is about 8.455×10⁻⁸ [F], the inductance of the inductive element L2 is about 1.005×10⁻¹¹ [H], the resistance of the resistive element R1 is about 1.000×10⁸ [Ω], the resistance of the resistive element R3 is about 9.780×10⁻³ [Ω]. The values of the other elements are also indicated in the table in FIG. 13. The circuits illustrated in FIGS. 10 to 13 are illustrative, and other elements may be used.

FIG. 14 illustrates an example of impedance changes with respect to frequency. In FIG. 14, the horizontal axis represents frequency [Hz] and the vertical axis represents impedance [Ω]. For example, as illustrated in FIGS. 10 to 12, by combining the capacitive elements C, the inductive elements L, and the resistive elements R, an impedance simulation value SM1 obtained from the SPICE model can be matched to a measurement value ME1. In other words, an equivalent circuit is created by coupling the capacitive elements C, the inductive elements L, and the resistive elements R so that the simulation value SM1 of the SPICE model matches the measurement value ME1.

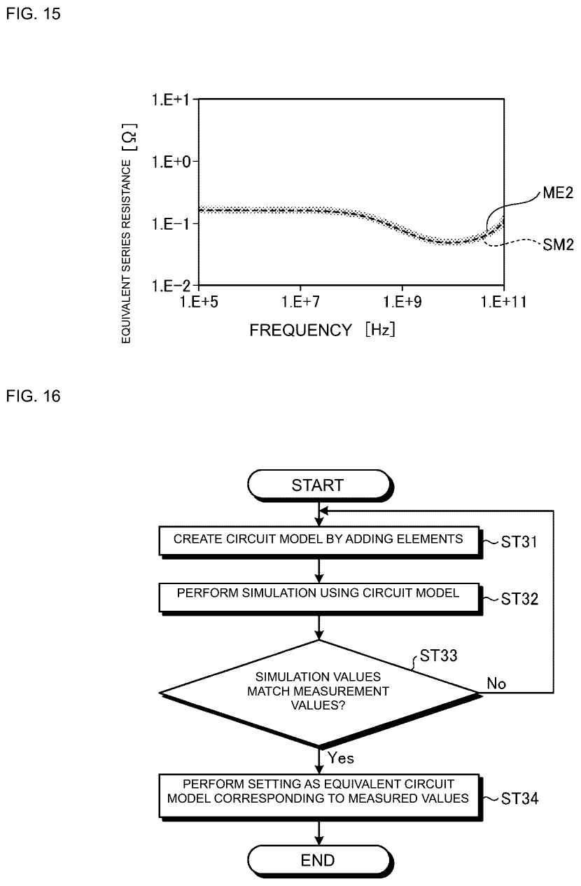

FIG. 15 illustrates an example of equivalent series resistance (ESR) changes with respect to frequency. In FIG. 15, the horizontal axis represents frequency [Hz] and the vertical axis represents equivalent series resistance [Ω]. For example, as illustrated in FIGS. 10 to 12, by combining the capacitive elements C, the inductive elements L, and the resistive elements R, an equivalent series resistance simulation value SM2 obtained from the SPICE model can be matched to a measurement value ME2. In other words, an equivalent circuit is created by coupling the capacitive elements C, the inductive elements L, and the resistive elements R so that the simulation value SM2 of the SPICE model matches the measurement value ME2.

FIG. 16 is a flowchart illustrating an example of the fitting process. In FIG. 16, firstly, a circuit model is created by adding a resistive element, inductive element, or capacitive element (step ST31). A simulation is performed using the circuit model created by adding a resistive element, inductive element, or capacitive element (step ST32).

Next, a determination is made to assess whether the simulation values obtained from the circuit model created by adding a resistive element, inductive element, or capacitive element match measurement values (step ST33). As a result of the determination in step ST33, when the simulation values match the measurement value (Yes in step ST33), the circuit model corresponding to the simulation value is created as an equivalent circuit model corresponding to the measured total impedance value of the circuit (step ST34).

By contrast, as a result of the determination in step ST33, when the simulation values do not match the measurement values (No in step ST33), the process returns to step ST31, and a new circuit model is created by further adding a resistive element, inductive element, or capacitive element. A simulation using the new circuit model is performed (step ST32), and a determination is made to assess whether the simulation values from the circuit model match the measurement values (step ST33). The operations described above are repeated until the simulation values from a circuit model match the measurement values. By repeating the operations described above, the simulation values can be gradually adjusted to approximate to the measurement values, and eventually, the simulation values can be matched to the measurement values. The simulation values matching the measurement values are used as the equivalent circuit model. By performing the fitting process using basic circuit elements such as resistive elements, inductive elements and capacitive elements, equivalent circuit models (for example, SPICE netlists) that are usable in general-purpose circuit simulators can be provided.

### Determination of Whether Match is Achieved

The determination of whether the simulation values match the measurement values in step ST33 in FIG. 16 may be made, for example, as follows. The measurement value is not constant and varies within ranges illustrated in FIGS. 14 and 15. When the simulation values continuously fall within the variation ranges of the measurement values, it can be determined that the simulation value matches the measurement value. Specifically, as illustrated in FIG. 14, the impedance measurement value ME1 varies within a specific variation range. When the simulation value SM1 continuously falls within the variation range of the measurement value ME1, it can be determined that the simulation value matches the measurement value. As illustrated in FIG. 15, the ESR measurement value ME2 varies within a specific variation range. When the simulation value SM2 continuously falls within the variation range of the measurement value ME2, it can be determined that the simulation value matches the measurement value.

It may be determined that the simulation values match the measurement values when the simulation values fall within specific variation ranges across a designated frequency range. For example, when the frequency band to be used is known in advance, a corresponding frequency range may be designated, and a determination may be made to assess whether the simulation values match the measurement values across the frequency range.

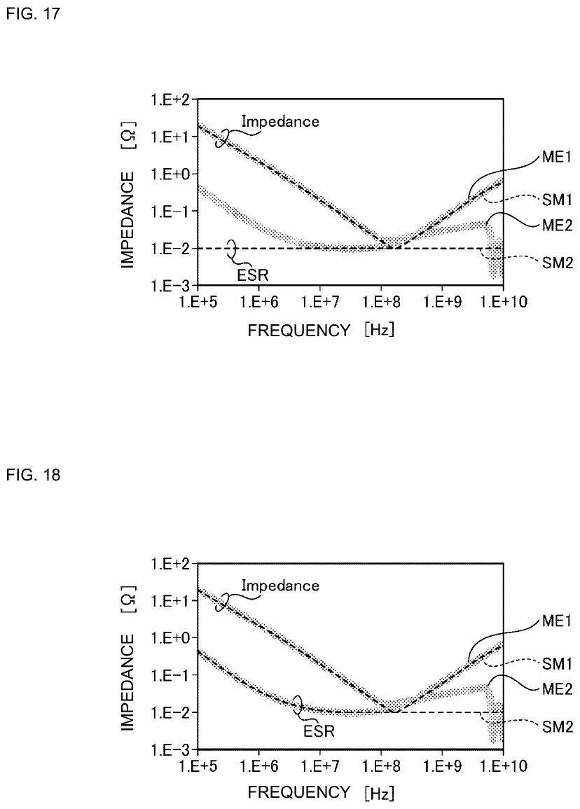

FIGS. 17 to 19 illustrate examples of the measurement values and the simulation values of impedance and ESR. In FIGS. 17 to 19, the horizontal axis represents frequency [Hz] and the vertical axis represents impedance [Ω]. By sequentially adding elements to create combinations as illustrated in the circuits in FIGS. 10 to 12, the process of matching the simulation value SM1 to the impedance measurement value ME1 and matching the simulation value SM2 to the ESR measurement value ME2, that is, the fitting process, is performed. At this time, by progressively adding elements to create various combinations, the waveform of the simulation value SM1 and the waveform of the simulation value SM2 can be matched to the measurement values ME1 and ME2 across lower to higher frequency ranges.

FIG. 17 corresponds to the equivalent circuit in FIG. 10. The equivalent circuit in FIG. 10 is an equivalent circuit using one resistive element for equivalent series resistance and one inductive element for equivalent series inductance. Since the equivalent series resistance is achieved with a small number of elements, the equivalent series resistance exhibits a flat, frequency-independent characteristic as illustrated in FIG. 17.

FIG. 18 corresponds to the equivalent circuit in FIG. 11. The equivalent circuit in FIG. 11 is an equivalent circuit created by additionally coupling three CR parallel circuits in series to the equivalent circuit in FIG. 10. As illustrated in FIG. 18, the frequency characteristic of the equivalent series resistance is reflected across lower frequencies.

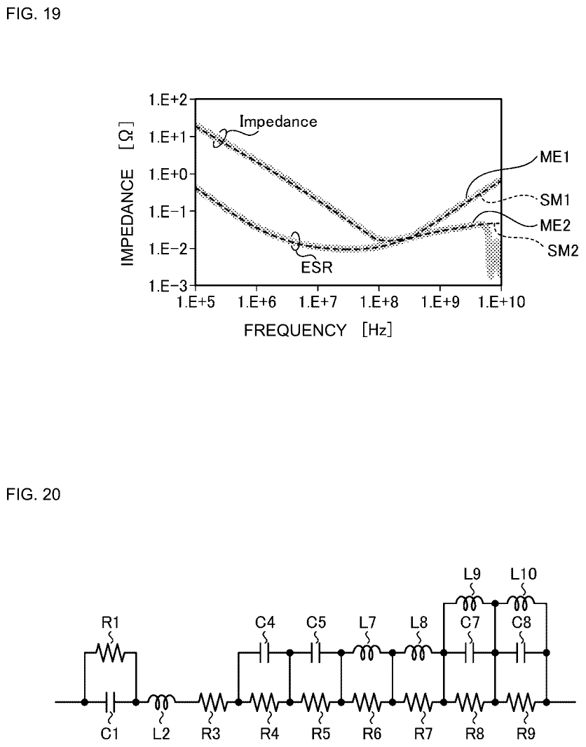

FIG. 19 corresponds to the equivalent circuit in FIG. 12. The equivalent circuit in FIG. 12 is an equivalent circuit created by additionally coupling two LR parallel circuits in series to the equivalent circuit in FIG. 11. As illustrated in FIG. 19, the frequency characteristics of the impedance and the equivalent series resistance are reflected in the frequency region higher than the self-resonant frequency.

Overall, the precision of matching the simulation values to the measurement values is higher in the case of FIG. 18 with the equivalent circuit in FIG. 11 than in the case of FIG. 17 with the equivalent circuit in FIG. 10. The precision of matching the simulation values to the measurement values is higher in the case of FIG. 19 with the equivalent circuit in FIG. 12 than in the case of FIG. 18 with the equivalent circuit in FIG. 11. As described above, by adding resistive elements, inductive elements, and capacitive elements, the precision of matching the simulation values to the measurement values can be improved.

As a result of performing the fitting process of matching the simulation values to the measurement values as described above, for example, a unit cell illustrated in FIG. 20 can be obtained. FIG. 20 illustrates an example unit cell. The unit cell illustrated in FIG. 20 includes resistive elements R1 and R3 to R9, capacitive elements C1, C4, C5, C7, and C8, and inductive elements L2 and L7 to L10. The capacitive element C1, the inductive element L2, and the resistive elements R3, R4, R5, R6, R7, R8, and R9 are coupled in series. The resistive element R1 is coupled in parallel with the capacitive element C1, the capacitive element C4 with the resistive element R4, the capacitive element C5 with the resistive element R5, the inductive element L7 with the resistive element R6, the inductive element L8 with the resistive element R7, the capacitive element C7 and the inductive element L9 with the resistive element R8, and the capacitive element C8 and the inductive element L10 with the resistive element R9. The resistive element R1 represents an insulation resistance.

### Array of Unit Cells

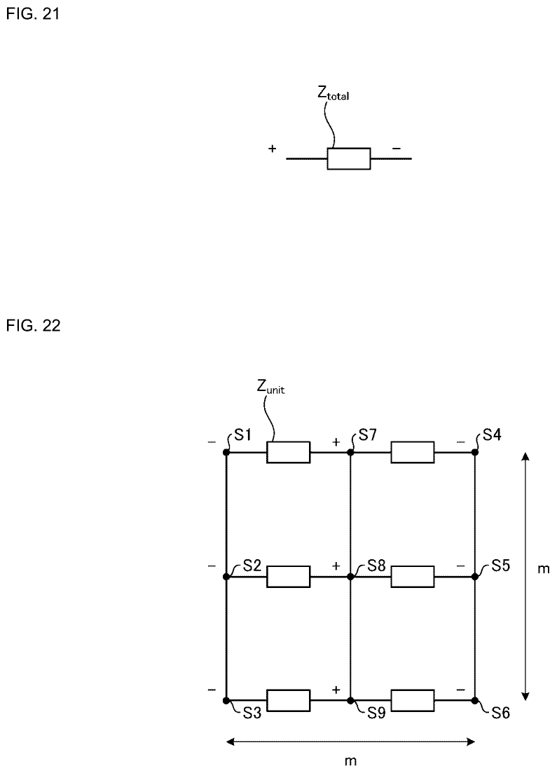

FIG. 21 illustrates an image of the total impedance Zₜₒₜₐₗ. FIG. 22 illustrates an example array of unit cells that corresponds to the total impedance Zₜₒₜₐₗ.

In FIG. 21, one end of the total impedance Zₜₒₜₐₗ corresponds to the positive pole (+), and the other end corresponds to the negative pole (−). The total impedance Zₜₒₜₐₗ is converted into an array consisting of m rows and n columns (m and n are natural numbers). In this example, when the array include m rows and n columns, the impedance Zᵤₙᵢₜ of a unit cell is determined by multiplying the total impedance Zₜₒₜₐₗ by a unit cell count K, which is the number of unit cells, given by K=m(n−1). Specifically, the impedance Zᵤₙᵢₜ of a unit cell is given by the following expression (2).

$${Z}_{unit} = K \cdot {Z}_{tota1} \qquad ( 2 )$$

As can be seen from Expression (2), the unit-cell impedance Zᵤₙᵢₜ can be derived from the total impedance Zₜₒₜₐₗ through simple calculation.

Using the above expression, the impedance of a unit cell is derived from the total impedance, while the specific periodic structure of the array is taken into account. For example, when the array is 3×3 as illustrated in FIG. 22, m=3 and n=3; accordingly, the unit cell count K is given as K=3·(3−1)=6. Thus, as illustrated in FIG. 22, six unit cells (K=6) are coupled in parallel. To divide the total impedance Zₜₒₜₐₗ into six unit cells coupled in parallel, the resistance and inductance are multiplied by 6, the capacitance is multiplied by ⅙ (K=6), and the resistance, the inductance, and the capacitance are assigned to each unit cell. Specifically, a resistance Rᵤₙᵢₜ of a unit cell is given by the following expression (3), an inductance Lᵤₙᵢₜ of the unit cell is given by the following expression (4), and a capacitance Cᵤₙᵢₜ of the unit cell is given by the following expression (5).

$${R}_{unit} = K \cdot {R}_{total} \qquad ( 3 )$$

$${L}_{unit} = K \cdot {L}_{total} \qquad ( 4 )$$

$${C}_{unit} = {C}_{total} / K \qquad ( 5 )$$

In Expression (3), Rₜₒₜₐₗ represents the resistance of the resistive element before the division into unit cells; in Expression (4), Lₜₒₜₐₗ represents the inductance of the inductive element before the division into unit cells; in Expression (5), Cₜₒₜₐₗ represents the capacitance of the capacitive element before the division into unit cells.

In other words, for the division into K unit cells coupled in parallel, the resistance and inductance are multiplied by K, and the capacitance is multiplied by 1/K. In this manner, the values of each element are multiplied by K or 1/K and assigned to each unit cell.

As a result of determining the values of each element as represented by the above expressions (3) to (5), the combined impedance of all the elements becomes equal to the original impedance Zₜₒₜₐₗ.

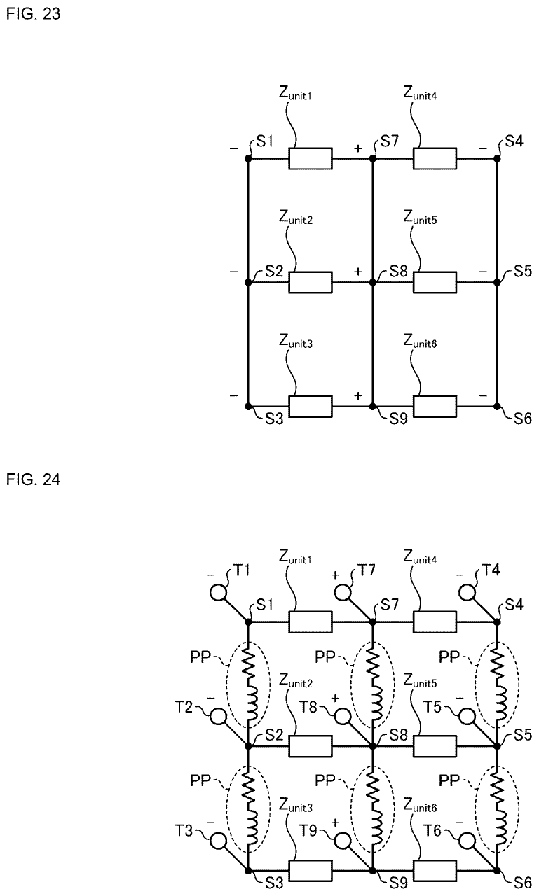

FIG. 23 illustrates unit-cell impedances positioned between the nodes of a two-dimensional grid consisting of m rows and n columns. In this example, six unit-cell impedances Zᵤₙᵢₜ₁ to Zᵤₙᵢₜ₆ are positioned between nodes S1 to S9 arranged in three rows and three columns. The three nodes S7 to S9 correspond to the positive pole. The nodes S1 to S3 and S4 to S6 correspond to the negative pole.

FIG. 24 illustrates an example equivalent circuit model of a multi-terminal capacitor. The equivalent circuit model in FIG. 24 is obtained by combining the unit-cell impedances Zᵤₙᵢₜ₁ to Zᵤₙᵢₜ₆ and the equivalent circuit model of a parasitic component PP in a two-dimensional grid and setting the positive or negative terminals T1 to T9 at nodes S1 to S9 in the two-dimensional grid. The parasitic component PP is the parasitic component of a substrate having the multi-terminal capacitor. The parasitic component PP include, for example, a resistive element and an inductive element coupled in series. By combining the parasitic component PP, an equivalent circuit model can be created that reflects parasitic components such as wire inductance and stray capacitance. As such, an equivalent circuit model with a topology corresponding to a multi-terminal capacitor structure can be provided.

### Example of Symbol

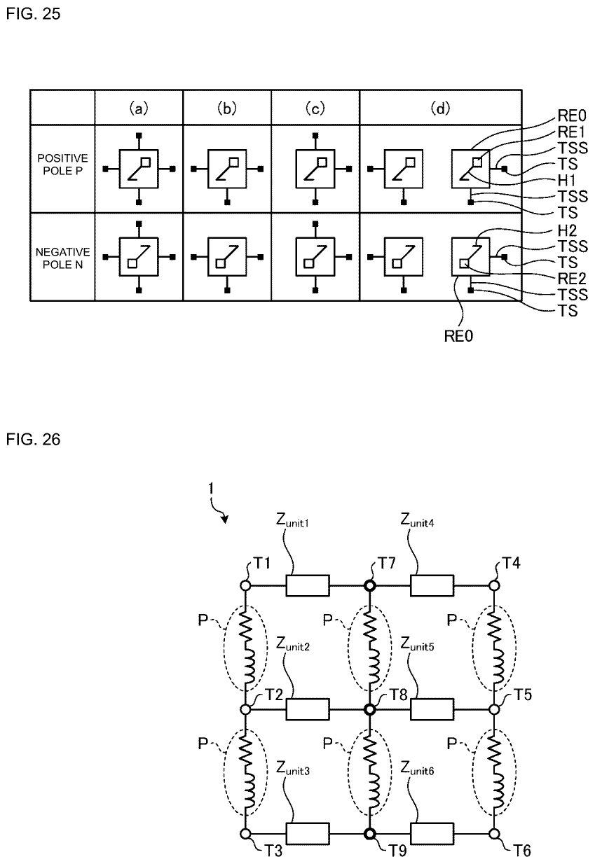

The equivalent circuit models of multi-terminal capacitors can be represented by symbols. FIG. 25 is a table illustrating an example of symbols representing equivalent circuit models of multi-terminal capacitors.

FIG. 25 illustrates symbols of the individual cells corresponding to two kinds of poles, specifically positive pole P and negative pole N. The items of (a) in FIG. 25 are symbols representing cells inside the array, that is, cells positioned at neither the corner portions nor the side portions. The items of (b) in FIG. 25 are symbols representing cells positioned at the side portions excluding the corner portions, having a different polarity from adjacent cells. The items of (c) in FIG. 25 are symbols representing cells positioned at the side portions excluding the corner portions, having an identical polarity to adjacent cells. The items of (d) in FIG. 25 are symbols representing cells positioned at the corner portions.

In FIG. 25, the symbols of the positive pole P include a white rectangle RE0, a rectangle RE1 positioned at the upper right of the rectangle RE0, a hook H1 extending from the rectangle RE1 toward the lower left of the rectangle RE0, black rectangles TS positioned outside the rectangle RE0, and line segments TSS connecting the rectangle RE0 and the rectangles TS. The black rectangles TS represent terminals coupled to adjacent cells. The number of rectangles TS is four in the items of (a) in FIG. 25. This means that four terminals are provided. The number of rectangles TS is three in the items of (b) and (c) in FIG. 25. This means that three terminals are provided. The number of rectangles TS is two in the items of (d) in FIG. 25. This means that two terminals are provided.

In FIG. 25, the symbols of the negative pole N include a white rectangle RE0, a rectangle RE2 positioned at the lower left of the rectangle RE0, a hook H2 extending from the rectangle RE2 toward the upper right of the rectangle RE0, black rectangles TS positioned outside the rectangle RE0, and line segments TSS connecting the rectangle RE0 and the rectangles TS. The black rectangles TS represent terminals coupled to adjacent cells. The number of rectangles TS is four in the items of (a) in FIG. 25. This means that four terminals are provided. The number of rectangles TS is three in the items of (b) and (c) in FIG. 25. This means s that three terminals are provided. The number of rectangles TS is two in the items of (d) in FIG. 25. This means that two terminals are provided.

FIG. 25 illustrates an example in which the symbols represent grid-like divisions. However, other kinds of symbols may be used.

FIG. 26 illustrates a multi-terminal capacitor with a terminal arrangement in three rows and three columns. Referring to FIG. 26, a unit cell of the impedance Zᵤₙᵢₜ₁ is coupled between the terminals T7 and T1, a unit cell of the impedance Zᵤₙᵢₜ₂ is coupled between the terminals T8 and T2, a unit cell of the impedance Zᵤₙᵢₜ₃ is coupled between the terminals T9 and T3, a unit cell of the impedance Zᵤₙᵢₜ₄ is coupled between the terminals T7 and T4, a unit cell of the impedance Zᵤₙᵢₜ₅ is coupled between the terminals T8 and T5, and a unit cell of the impedance Zᵤₙᵢₜ₆ is coupled between the terminals T9 and T6.

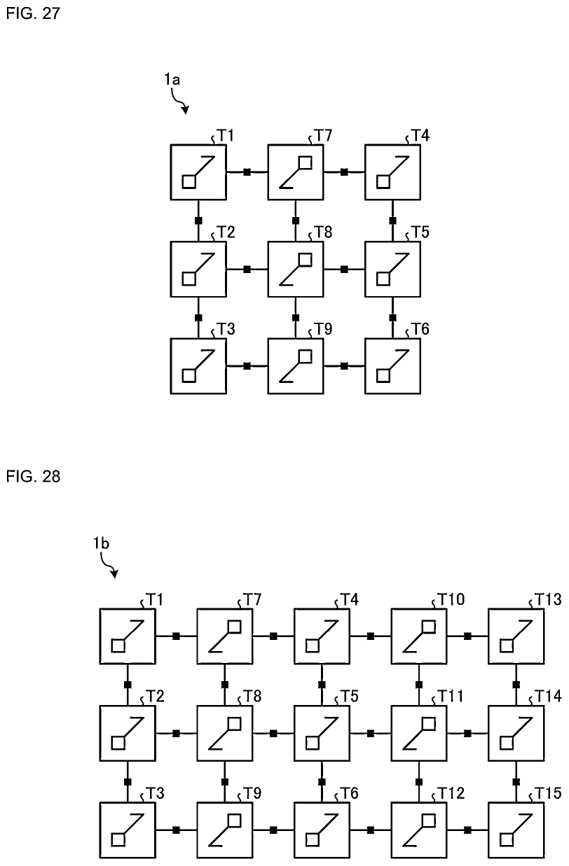

FIG. 27 illustrates a multi-terminal capacitor illustrated using the symbols presented in FIG. 25. FIG. 27 illustrates a multi-terminal capacitor 1a, which is equivalent to the multi-terminal capacitor illustrated in FIG. 26.

The unit-cell impedance Zᵤₙᵢₜ₁ between the terminals T7 and T1 in FIG. 26 is equally assigned to the symbol of the terminal T7 and the symbol of the terminal T1 at the same locations in FIG. 27. Specifically, the impedance Zᵤₙᵢₜ₁/2 is set to the symbol of the terminal T7 and the symbol of the terminal T1.

The unit-cell impedance Zᵤₙᵢₜ₂ between the terminals T8 and T2 in FIG. 26 is equally assigned to the symbol of the terminal T8 and the symbol of the terminal T2 at the same locations in FIG. 27. Specifically, the impedance Zᵤₙᵢₜ₂/2 is set to the symbol of the terminal T8 and the symbol of the terminal T2.

The unit-cell impedance Zᵤₙᵢₜ₃ between the terminals T9 and T3 in FIG. 26 is equally assigned to the symbol of the terminal T9 and the symbol of the terminal T3 at the same locations in FIG. 27. Specifically, the impedance Zᵤₙᵢₜ₃/2 is set to the symbol of the terminal T9 and the symbol of the terminal T3.

The unit-cell impedance Zᵤₙᵢₜ₄ between the terminals T7 and T4 in FIG. 26 is equally assigned to the symbol of the terminal T7 and the symbol of the terminal T4 at the same locations in FIG. 27. Specifically, the impedance Zᵤₙᵢₜ₄/2 is set to the symbol of the terminal T7 and the symbol of the terminal T4.

The unit-cell impedance Zᵤₙᵢₜ₅ between the terminals T8 and T5 in FIG. 26 is equally assigned to the symbol of the terminal T8 and the symbol of the terminal T5 at the same locations in FIG. 27. Specifically, the impedance Zᵤₙᵢₜ₅/2 is set to the symbol of the terminal T8 and the symbol of the terminal T5.

The unit-cell impedance Zᵤₙᵢₜ₆ between the terminals T9 and T6 in FIG. 26 is equally assigned to the symbol of the terminal T9 and the symbol of the terminal T6 at the same locations in FIG. 27. Specifically, the impedance Zᵤₙᵢₜ₆/2 is set to the symbol of the terminal T9 and the symbol of the terminal T6.

As described with reference to FIGS. 26 and 27, setting symbols that correspond to the elements defining multi-terminal capacitors facilitates editing circuit diagrams using circuit simulators, such as changing terminal arrangements. For example, the multi-terminal capacitor 1a with a terminal arrangement in three rows and three columns illustrated in FIG. 27 can be easily transformed into a multi-terminal capacitor 1b with a terminal arrangement in three rows and five columns illustrated in FIG. 28. FIG. 28 illustrates a multi-terminal capacitor with a terminal arrangement in three rows and five columns. The multi-terminal capacitor 1b illustrated in FIG. 28 has fifteen terminals T1 to T15. In this example, the impedance of the symbol corresponding to the terminal T4 is equally divided between the symbol of the terminal T10 and the symbol of the terminal T13; the impedance of the symbol corresponding to the terminal T5 is equally divided between the symbol of the terminal T11 and the symbol of the terminal T14; and the impedance of the symbol corresponding to the terminal T6 is equally divided between the symbol of the terminal T12 and the symbol of the terminal T15. As a result, the multi-terminal capacitor 1a with a terminal arrangement in three rows and three columns can be transformed into the multi-terminal capacitor 1b with a terminal arrangement in three rows and five columns.

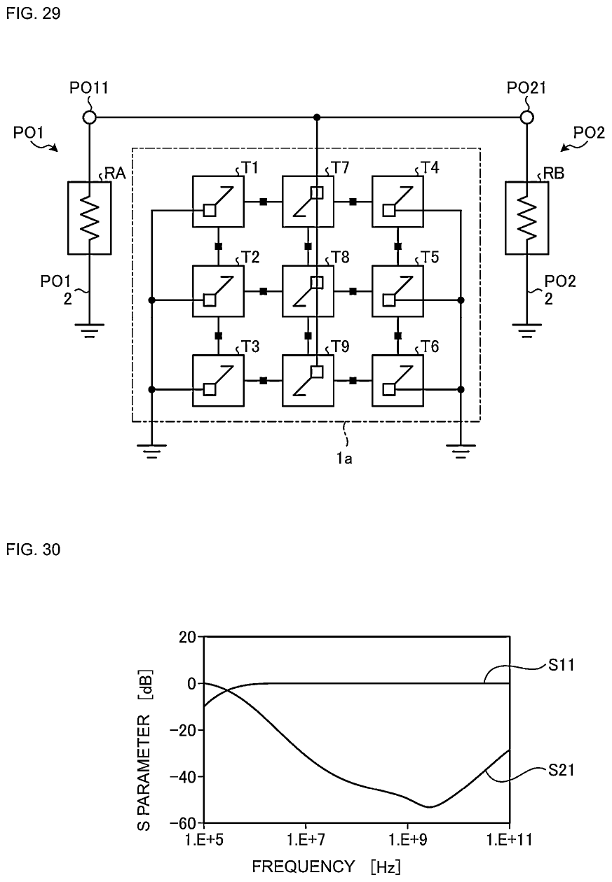

FIG. 29 illustrates an equivalent circuit of the substrate 10a including the multi-terminal capacitor 1 described with reference to FIG. 6. FIG. 29 visualizes the multi-terminal capacitor 1a using the symbols described with reference to FIG. 25. In the multi-terminal capacitor 1a in FIG. 29, the terminals T7 to T9 corresponding to three symbols of the positive pole are electrically coupled to the positive pole PO11 of the port PO1 and the positive pole PO21 of the port PO2. The terminals T1 to T6 corresponding to six symbols of the negative pole are electrically coupled to a reference potential, for example ground. The resistor RA is electrically coupled between the positive pole PO11 and the negative pole PO12 of the port PO1. The resistor RB is electrically coupled between the positive pole PO21 and the negative pole PO22 of the port PO2. With the connections as illustrated in FIG. 29, S parameters of the multi-terminal capacitor 1a can be obtained for impedance evaluation using a shunt-through method.

FIG. 30 illustrates an example simulation result regarding S parameters. In FIG. 30, the horizontal axis represents frequency [Hz], and the vertical axis represents S parameter [dB]. FIG. 30 illustrates S11 and S21 among S parameters. S11 is equal to the value obtained by dividing the power reflected from the port PO1 by the power entering the port PO1. S21 is equal to the power gain when the impedance of the power supply and the impedance of the load are 50Ω.

### Application Example of Multi-Terminal Capacitor

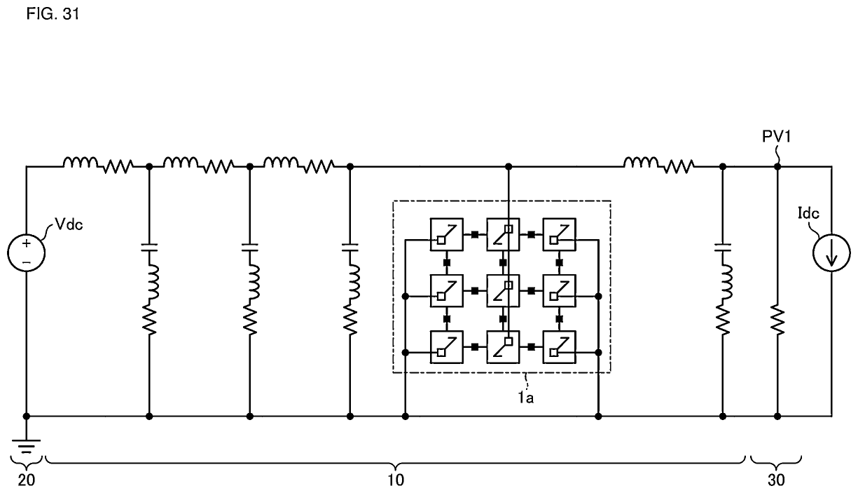

FIG. 31 illustrates an example of simulation in the time domain. In this example, power can be supplied from a direct-current (DC) power supply 20 to a load 30 via the substrate 10. A voltage Vdc from the DC power supply 20 can be supplied to the load 30 via the substrate 10. In this example, a current supply Idc is provided, coupled in parallel with the load 30. The connections of a resistive element and an inductive element and the connections of a resistive element, an inductive element, and a capacitive element in FIG. 31 represent the equivalent circuit of the substrate 10. The load 30 is, for example, a semiconductor chip such as a controller or processor.

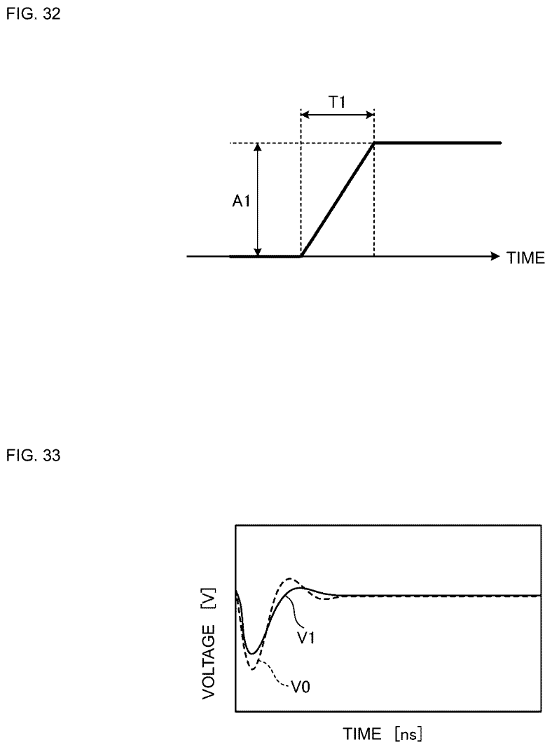

FIG. 32 illustrates the change in current from the current supply Idc in FIG. 31. In FIG. 32, the horizontal axis represents a time Ti spent for current rise, and the vertical axis represents an amplitude Ai.

FIG. 33 illustrates examples of the change in load voltage. In FIG. 33, the horizontal axis represents time [ns], and the vertical axis represents voltage [V]. The dashed line in FIG. 33 illustrates a voltage V0 when the multi-terminal capacitor 1a is not provided. The solid line in FIG. 33 illustrates a voltage V1 when the multi-terminal capacitor 1a is provided.

In FIGS. 31 to 33, in response to the operation of the load 30, the value of the current from the current supply Idc can increase, or the load voltage can decrease in certain situations. For example, as illustrated in FIG. 33, the load voltage first decreases and then starts to decrease in certain situations. In such a case, the variation in the load voltage can be reduced or suppressed by charging or discharging the multi-terminal capacitor 1a provided at the substrate 10. As illustrated in FIG. 33, the voltage V1 when the multi-terminal capacitor 1a is provided varies less than the voltage V0 when the multi-terminal capacitor 1a is not provided.

### Simulation Device

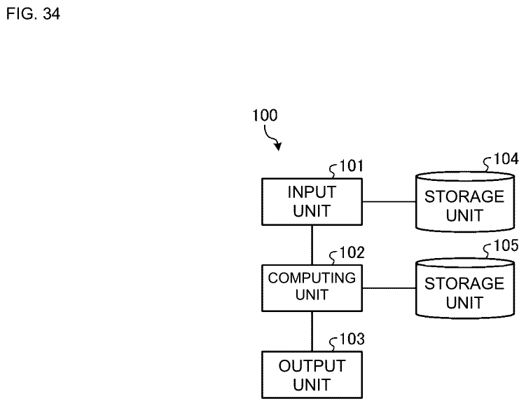

FIG. 34 illustrates an example configuration of a simulation device according to an example embodiment of the present invention. A simulation device 100 illustrated in FIG. 34 is provided with a program to calculate the characteristics of multi-terminal capacitors or the characteristics of circuits coupled with multi-terminal capacitors. In FIG. 34, the simulation device includes an input 101, a computing unit 102, an output 103, and storages 104 and 105.

The input 101 is operable to receive inputs of data regarding, for example, conditions for setting equivalent circuit models. The input 101 includes, for example, a keyboard and a mouse.

The computer 102 is configured or programmed to run a program stored on a non-transitory computer readable storage medium using the data inputted through the input 101. The computer 102 includes, for example, a central processing unit (CPU).

The output 103 is operable to display, for example, computation results obtained by the computer 102 and characteristic waveforms obtained by a simulator. The output 103 is, for example, a display.

The storage 104 is operable to store data of equivalent circuit models. The data of equivalent circuit models stored by the storage 104 includes, for example, data of the multi-terminal capacitor 1a illustrated in FIG. 27, or data of the multi-terminal capacitor 1b illustrated in FIG. 28. The storage 105 is operable to store a program for executing a simulator. The simulator stored in the storage 105 (the storage being a non-transitory computer readable medium) is configured to calculate the characteristics of multi-terminal capacitors or the characteristics of circuits coupled with multi-terminal capacitors. The storage 104 and 105 may be, for example, magnetic disk devices or semiconductor memories.

In FIG. 34, data inputted through the input 101 and data of equivalent circuit models can be stored in the storage 104. The computing unit 102 executes the program stored in the storage 105 and starts the simulator. The computing unit 102 performs computation using the simulator. The output 103 outputs characteristic waveforms obtained as a result of the computation by the computing unit 102 and other kinds of data in the form of, for example, graph.

The simulation device illustrated in FIG. 34 is preferably provided with a program to calculate the characteristics of multi-terminal capacitors or the characteristics of circuits coupled with multi-terminal capacitors. By using the simulation device provided with the data of equivalent circuit models and program that can be used to calculate the characteristics of multi-terminal capacitors, circuit design of electronic devices using multi-terminal capacitors can be carried out efficiently and accurately. This provides an efficient design environment for designers. Furthermore, by providing the simulation device that simplifies displaying and comparing the characteristics of multi-terminal capacitors, the efficiency of component selection tasks for designers can be enhanced. For example, the user can perform operations on a web page to design a desired multi-terminal capacitor. Subsequently, the S parameters of the multi-terminal capacitor can be measured. Accordingly, an equivalent circuit model that can achieve frequency characteristic waveforms of the S parameters can be created by selecting elements that match the waveforms and combining the selected elements. The created equivalent circuit model of the multi-terminal capacitor can then be used to calculate the characteristics of the multi-terminal capacitor or the characteristics of a circuit including the multi-terminal capacitor.

Overall, the simulation device illustrated in FIG. 34 is a device to calculate the characteristics of a multi-terminal capacitor or the characteristics of a circuit including the multi-terminal capacitor by using an equivalent circuit model of the multi-terminal capacitor created through the equivalent circuit model creation method described above. By using this simulation device, a simulation method can be implemented. This simulation method calculates the characteristics of a multi-terminal capacitor or the characteristics of a circuit including the multi-terminal capacitor by using an equivalent circuit model of the multi-terminal capacitor created through the equivalent circuit model creation method described above. The characteristics of multi-terminal capacitors and the characteristics of circuits with multi-terminal capacitors, such as circuits coupled with multi-terminal capacitors, can be evaluated using various methods pertaining to different aspects such as the frequency domain and the time domain. By providing equivalent circuit models of various multi-terminal capacitors as a library, the characteristics of multi-terminal capacitors can be evaluated in a simulation environment specified by the user. By providing a dedicated simulation device, input operations such as model setting and output operations such as graph display can be easily performed, thereby enhancing user convenience.

### Equivalent Circuit Model Creation Program

A program for implementing the equivalent circuit model creation method described with reference to FIG. 1 may be created and run by, for example, a computer including a microprocessor, a controller, logic hardware, etc. This program is an equivalent circuit model creation program to create an equivalent circuit model of a multi-terminal capacitor including a configuration in which positive and negative outer electrode terminal linear arrays are alternately arranged in parallel. The equivalent circuit model creation program is configured to cause the computer to execute a process including a first step of measuring S parameters of the multi-terminal capacitor, a second step of deriving a total impedance of the multi-terminal capacitor based on S-parameter measurement values measured in the first step, a third step of creating a two-terminal equivalent circuit model from the total impedance of the multi-terminal capacitor derived in the second step, a fourth step of deriving a unit-cell equivalent circuit model from the two-terminal equivalent circuit model created in the third step, a fifth step of creating a two-dimensional grid topology by combining the unit-cell equivalent circuit model derived in the fourth step and a parasitic-component equivalent circuit model, and a sixth step of setting terminals of the multi-terminal capacitor at nodes in the two-dimensional grid topology created in the fifth step. This equivalent circuit model creation program can be stored in, for example, the storage 105 in FIG. 34. This equivalent circuit model creation program can be, for example, read from the storage 105 and executed by the computing unit 102 in FIG. 34. This equivalent circuit model creation program may be stored in a non-transitory computer readable storage medium detachable from the computer. For example, the equivalent circuit model creation program may be stored in a Universal Serial Bus (USB) flash drive.

According to the above method, equivalent circuit models of multi-terminal capacitors with outer electrode terminals arranged in a grid can be created. Positive and negative linear arrays of outer electrode terminals may be alternately arranged in parallel, forming a striped arrangement. The impedance of a multi-terminal capacitor can be derived from S-parameter measurement values measured using a mounting installation involving a substrate having two ports. Because the measurement method using two ports instead of multiple ports is employed, the man-hours of measurement evaluation can be reduced.

A two-terminal equivalent circuit model can be created by the fitting process, based on the derived total impedance. The unit-cell impedance can be derived from the total impedance, while the specific periodic structure of a grid-like equivalent circuit model is taken into account. A two-dimensional grid topology can be created by combining a unit-cell equivalent circuit model and a wire equivalent circuit model as circuit elements. By setting terminals at the nodes in the grid, an overall equivalent circuit model can be created. As such, an equivalent circuit model with a topology corresponding to a multi-terminal capacitor structure can be created. Repeatedly using the characteristics of a unit cell reduces the amount of calculation in circuit simulation. Furthermore, a SPICE model with high accuracy and low computational cost can be provided for both the time and frequency domains.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An equivalent circuit model creation method for creating an equivalent circuit model of a multi-terminal capacitor including positive and negative outer electrode terminal linear arrays alternately arranged in parallel or substantially in parallel, the equivalent circuit model creation method comprising:
measuring S parameters of the multi-terminal capacitor;
deriving a total impedance of the multi-terminal capacitor based on S-parameter measurement values measured in the measuring the S parameters;
creating a two-terminal equivalent circuit model from the total impedance of the multi-terminal capacitor derived in the deriving the total impedance of the multi-terminal capacitor;
deriving a unit-cell equivalent circuit model from the two-terminal equivalent circuit model created in the creating the two-terminal equivalent circuit model;
creating a two-dimensional grid topology by combining the unit-cell equivalent circuit model derived in the deriving the unit-cell equivalent circuit model and a parasitic-component equivalent circuit model; and
setting terminals of the multi-terminal capacitor at nodes in the two-dimensional grid topology created in the creating the two-dimensional grid topology.

2. The equivalent circuit model creation method according to claim 1, wherein, in the creating the two-terminal equivalent circuit model, the two-terminal equivalent circuit model is created through a fitting process of adjusting simulation values to approximate the S-parameter measurement values.

3. The equivalent circuit model creation method according to claim 2, wherein, in the fitting process, the two-terminal equivalent circuit model is created by progressively coupling circuit elements to match the S-parameter measurement values.

4. The equivalent circuit model creation method according to claim 1, wherein, in the deriving the unit-cell equivalent circuit model, for division into K unit cells coupled in parallel or substantially in parallel, a resistance and an inductance are multiplied by K, a capacitance is multiplied by 1/K, and the resistance, the inductance, and the capacitance are assigned to each unit cell.

5. The equivalent circuit model creation method according to claim 1, wherein, in the measuring the S parameters, the S parameters are measured using a jig that includes a substrate incorporating the multi-terminal capacitor.

6. A non-transitory computer-readable medium including an equivalent circuit model creation program for creating an equivalent circuit model of a multi-terminal capacitor including a configuration in which positive and negative outer electrode terminal linear arrays are alternately arranged in parallel or substantially in parallel, the equivalent circuit model creation program causing a computer to execute a process comprising:
measuring S parameters of the multi-terminal capacitor;
deriving a total impedance of the multi-terminal capacitor based on S-parameter measurement values measured in the measuring the S parameters;
creating a two-terminal equivalent circuit model from the total impedance of the multi-terminal capacitor derived in the deriving the total impedance of the multi-terminal capacitor;
deriving a unit-cell equivalent circuit model from the two-terminal equivalent circuit model created in the creating the two-terminal equivalent circuit model;
creating a two-dimensional grid topology by combining the unit-cell equivalent circuit model derived in the deriving the unit-cell equivalent circuit model and a parasitic-component equivalent circuit model; and
setting terminals of the multi-terminal capacitor at nodes in the two-dimensional grid topology created in the creating the two-dimensional grid topology.

7. A simulation method for calculating characteristics of a multi-terminal capacitor or characteristics of a circuit including the multi-terminal capacitor by using an equivalent circuit model of the multi-terminal capacitor created through the equivalent circuit model creation method according to claim 1.

8. A simulation device to calculate characteristics of a multi-terminal capacitor or characteristics of a circuit including the multi-terminal capacitor by using an equivalent circuit model of the multi-terminal capacitor created through the equivalent circuit model creation method according to claim 1.

9. The equivalent circuit model creation method according to claim 1, wherein the multi-terminal capacitor includes a substrate on which negative electrodes and a positive electrode are provided.

10. The equivalent circuit model creation method according to claim 9, wherein the negative electrodes and the positive electrode are arranged in a stripped pattern and extend parallel to each other.

11. The equivalent circuit model creation method according to claim 9, wherein each of the negative electrodes and the positive electrode include multiple terminals.

12. The equivalent circuit model creation method according to claim 9, wherein the positive electrode is located between the negative electrodes.

13. The equivalent circuit model creation method according to claim 5, wherein the jig includes a negative jig electrode and a positive jig electrode within the substrate, the negative jig electrode and the positive jig electrode being respectively connected to the positive and negative outer electrode terminal linear arrays.

14. The equivalent circuit model creation method according to claim 13, wherein the substrate includes ports which are respectively connected to the negative jig electrode and the positive jig electrode.
